(19) United States
(12) Patent Application Publication
(10) Pub. No.: US 2025/0065714 A1
(43) Pub. Date: Feb. 27, 2025

(54) Transmission

(71) Applicant: J. C. Bamford Excavators Limited, Uttoxeter (GB)

(72) Inventors: Alan Williams, Uttoxeter (GB); George Baston, Uttoxeter (GB); Edward Owston, Uttoxeter (GB)

(73) Assignee: J. C. Bamford Excavators Limited, Uttoxeter (GB)

(21) Appl. No.: 18/813,007

(22) Filed: Aug. 22, 2024

(30) Foreign Application Priority Data
Aug. 25, 2023 (GB) 2313011.5

(51) Int. Cl. B60K 17/10

(52) U.S. Cl. CPC B60K 17/105; B60Y 2200/15

(57) ABSTRACT

A transmission system for a working vehicle includes a hydraulic drive motor 38 and a transmission 100. The transmission includes an output member 102; a first input member 104 connectable to a prime mover, wherein the transmission is operable to transmit drive from the first input member via a first drive path 108 to the output member in a mechanical drive mode; and a second input member 106 drivable by the operation of the hydraulic drive motor, wherein the transmission is operable to transmit drive from the second input member via a second drive path 110 to the output member in a hydrostatic drive mode. The transmission is configured so that there is a fixed ratio of rotation speed of the first input member to rotation speed of the output member in the mechanical drive mode.

### FIELD

The present teachings relate to a transmission, a transmission system, a driveline layout, and a working vehicle.

### BACKGROUND

Vehicles, such as working vehicles, typically include a driveline arrangement which includes a prime mover, a transmission for transferring mechanical power from the prime mover to a driveshaft, and a ground engaging structure (e.g., including axles and wheels) driven by the driveshaft.

One type of known transmission is a mechanical transmission, which typically has a mechanical drive train with a plurality of alternative gear ratios which are selectable by a gear ratio selection apparatus. Another type of known transmission is a hydrostatic transmission, which includes a hydraulic pump driven by the prime mover and a hydraulic drive motor supplied with hydraulic fluid from the hydraulic pump.

It is an aim of the present teachings to address one or more of the disadvantages associated with the prior art.

### SUMMARY

An aspect of the teachings provides a transmission for a working vehicle comprising a ground engaging structure. The transmission comprises: an output member for driving the ground engaging structure; a first input member connectable to a prime mover, wherein the transmission is operable to transmit drive from the first input member via a first drive path to the output member in a mechanical drive mode; and a second input member drivable by the operation of a hydraulic drive motor, wherein the transmission is operable to transmit drive from the second input member via a second drive path to the output member in a hydrostatic drive mode. The transmission is configured so that there is a fixed ratio of rotation speed of the first input member to rotation speed of the output member in the mechanical drive mode.

In other words, the first drive path defines a fixed gear ratio, and there are no other drive paths connecting the first input member to the output member. This contrasts with arrangements which include a mechanical drive train with a plurality of alternative gear ratios which are selectable by a gear ratio selection apparatus.

An advantage of having a fixed ratio of rotation speed of the first input member to rotation speed of the output member is that it reduces the number of components required compared to arrangements with multi-ratio drive trains. This provides a more compact transmission which is easier and cheaper to manufacture.

Furthermore, it has been found that a suitable driving performance for a working vehicle can be obtained by having a hydrostatic drive mode for lower speed driving and a mechanical drive mode with a fixed gear ratio for higher speed driving. This contrasts with the conventional approach of having mechanical drive trains with a plurality of alternative gear ratios for different speeds of driving, even when an additional hydrostatic drive mode is provided.

Optionally, the first input member and the output member are spaced apart from each other by a spacing distance transverse to their respective axes of rotation, wherein the spacing distance is at least 220 mm, optionally at least 240 mm, optionally at least 260 mm, optionally at least 280 mm, optionally at least 300 mm, optionally at least 320 mm, optionally at least 340 mm.

In other words, the transmission is configured to connect a prime mover having an axis of rotation to one or more driveshafts (for driving the ground engaging structure) having an axis of rotation which is spaced apart from the prime mover by such a spacing distance transverse to the respective axes of rotation.

Optionally, the transmission is configured to be mounted in a driveline arrangement so that the first input member is provided vertically above the output member.

In other words, the transmission is configured to be mounted in a driveline arrangement so that the spacing distance between the first input member and the output member is a vertical spacing. Put another way, such a transmission is configured to be provided in a “long-drop” configuration which is useful for applications where the prime mover has an output shaft which is substantially higher than a driveshaft of the working vehicle. For example, in articulated loaders or telescopic handlers where the engine is mounted higher than in other working vehicles such as fixed body telescopic handlers.

Optionally, the transmission comprises a first side and a second side, wherein the first input member is connectable to a prime mover at the first side of the transmission, and wherein the second input member is connectable to the hydraulic drive motor at the first side of the transmission.

In other words, when the transmission is provided as part of a driveline arrangement, both input drives (prime move/hydraulic drive motor) are provided on the same side of the transmission, rather than being provided on opposing sides of the transmission. This may facilitate a more compact arrangement at the second side of the transmission, which may be particularly useful for articulated working vehicles such as articulated loaders or articulated telescopic handlers.

Optionally, the transmission comprises a first clutch device having an engaged state configured to connect the first input member to the first drive path when the transmission is in the mechanical drive mode, and a disengaged state configured to disconnect the first input member from the first drive path when the transmission is in the hydrostatic drive mode.

Such a first clutch device provides a simple means of selectively putting the transmission in the mechanical drive mode.

Optionally, the transmission comprises a second clutch device having an engaged state configured to connect the second input member to the second drive path when the transmission is in the hydrostatic drive mode, and a disengaged state configured to disconnect the second input member from the second drive path when the transmission is in the mechanical drive mode.

Such a second clutch device provides a simple means of selectively putting the transmission in the hydrostatic drive mode.

Optionally, the first drive path comprises: a first input gear configured for rotation with the first input member when the transmission is in the mechanical drive mode, an output gear carried on the output member for rotation with the output member, a first layshaft between the first input member and the output member, and one or more intermediate gears carried on the first layshaft for rotation with the first layshaft, each of the one or more intermediate gears of the first layshaft being in permanent mesh with the first input gear and/or output gear.

Such an arrangement provides a simple means for transferring drive from the first input member to the output member. Furthermore, by having a layshaft (instead of directly meshing the first input gear and the output gear), there is increased flexibility in packaging of the transmission. For example, the first input member and the output member can be spaced apart by a greater distance, which may be useful for applications where an output shaft of the prime mover is spaced apart from a driveshaft of the working vehicle.

Optionally, the one or more intermediate gears of the first layshaft comprise a single idler gear in permanent mesh with both the first input gear and the output gear.

Such an idler gear allows a distance between the first input gear and the output gear to be increased, without impacting the fixed gear ratio. This may be useful for applications where an output shaft of the prime mover is spaced apart from a driveshaft of the working vehicle by a large distance.

Optionally, the first input gear, idler gear and output gear are arranged in an approximately vertical line in which the idler gear is positioned below the first input gear and the output gear is positioned below the idler gear.

Such an arrangement provides a “long-drop” configuration which is useful for applications where an output shaft of the prime mover is substantially higher than a driveshaft of the working vehicle. For example, in articulated loaders or telescopic handlers where the engine is mounted higher than in other working vehicles such as fixed body telescopic handlers.

Optionally, the second drive path comprises: a second input gear configured for rotation with the second input member when the transmission is in the hydrostatic drive mode, an output gear carried on the output member for rotation with the output member, a second layshaft between the second input gear and the output gear, and one or more intermediate gears carried on the second layshaft for rotation with the second layshaft, each of the one or more intermediate gears of the second layshaft being in permanent mesh with the second input gear and/or output gear.

Such an arrangement provides a simple means for transferring drive from the second input member to the output member. Furthermore, by having a layshaft (instead of directly meshing the second input gear and the output gear), there is increased flexibility in packaging of the transmission. For example, a gear ratio between the second input gear and the output gear can be set by selecting the number of teeth on intermediate gears on the layshaft, without having to change the size of the second input gear or output gear.

Optionally, the one or more intermediate gears of the second layshaft comprise a first intermediate gear in permanent mesh with the second input gear and a second intermediate gear in permanent mesh with the output gear.

In this way, a gear ratio between the second input gear and the output gear can be set by selecting the number of teeth on the first and second intermediate gears, without having to change the size of the second input gear or output gear.

Optionally, the first intermediate gear comprises more teeth than the second intermediate gear.

In this way, a gear ratio between the second input gear and the output gear can be influenced by the different number of teeth of the first and second intermediate gears.

Optionally, the transmission comprises a V-shaped layout in which the output member is provided at a lower end of the V-shaped layout, the first input member and first layshaft define a first side of the V-shaped layout, and the second input member and second layshaft define a second side of the V-shaped layout.

Such a V-shaped layout provides a package which is easy to reconfigure by removing one side of the V-shaped layout. For example, for applications where only a hydrostatic drive mode is required, the first input member and first layshaft can easily be omitted by virtue of being on a different side of the V-shaped configuration, without having to alter a casing of the transmission.

A further aspect of the teachings provides a transmission system comprising a hydraulic drive motor and a transmission as disclosed herein.

Optionally, the transmission system further comprises a control system configured to engage the transmission in the hydrostatic drive mode when the working vehicle is travelling at speeds below a threshold speed, and to engage the transmission in the mechanical drive mode when the working vehicle is travelling at speeds at or above the threshold speed.

Optionally, the threshold speed is greater than 20 km/h, optionally greater than 25 km/h, optionally greater than 30 km/h, optionally greater than 35 km/hour, optionally greater than 40 km/hour.

Known hydrostatic drives on hybrid transmissions are limited to less than 20 km/h speeds, with a mechanical drive being used for speeds above 20 km/h. Since working vehicles are sometimes required to travel at significantly higher speeds than 20 km/h (e.g., when travelling along the road), the mechanical drives on such transmissions have used multiple gear ratios. For example, the mechanical drive may have a first gear ratio optimized for speeds of 20-30 km/h, a second gear ratio optimized for speeds of 30-40 km/h, and a third gear ratio optimized for speeds above 40 km/h. However, it has been found that by having a threshold speed for the hydrostatic drive mode which is greater than 20 km/h (e.g., greater than 25, 30, 35, or 40 km/h), good mechanical driving performance can be achieved with a fixed gear ratio instead. This allows the number of components of the transmission to be reduced, which simplifies manufacturing and reduces costs.

A further aspect of the teachings provides a driveline arrangement for a working vehicle comprising a ground engaging structure, the driveline arrangement comprising a transmission as disclosed herein. Such a driveline arrangement benefits from the advantages of the transmission outlined above.

Optionally, the driveline arrangement comprises a prime mover configured to drive the first input member of the transmission.

Optionally, the driveline arrangement comprises a hydraulic drive motor configured to drive the second input member of the transmission.

Optionally, the driveline arrangement comprises a hydraulic pump for supplying pressurized hydraulic fluid to drive the hydraulic drive motor. Optionally, the hydraulic pump is drivable by the prime mover.

Optionally, the driveline arrangement comprises one or more output driveshafts coupled to the output member of the transmission, for driving the ground engaging structure of the working vehicle.

Optionally, the hydraulic pump is a through-driven hydraulic pump positioned between the prime mover and the first input member of the transmission.

In other words, the hydraulic pump comprises an input side directly coupled to an output driveshaft of the prime mover and an output side directly coupled to an intermediate driveshaft for driving the first input member of the transmission.

Such a configuration provides a more compact driveline arrangement than alternative arrangements, for example, arrangements in which the hydraulic pump is coupled to an output shaft of the transmission.

Optionally, the driveline arrangement further comprises an intermediate driveshaft for driving the first input member of the transmission, wherein the hydraulic pump comprises an input side directly coupled to an output driveshaft of the prime mover and an output side directly coupled to the intermediate driveshaft.

Such a configuration provides a more compact driveline arrangement than alternative arrangements, for example, arrangements in which the hydraulic pump is coupled to an output shaft of the transmission.

Optionally, the hydraulic pump is mounted directly to the prime mover. This provides a compact arrangement.

Optionally, the first input member of the transmission and the output member of the transmission are spaced apart from each other by a spacing distance transverse to their respective axes of rotation, wherein the spacing distance is at least 220 mm, optionally at least 240 mm, optionally at least 260 mm, optionally at least 280 mm, optionally at least 300 mm, optionally at least 320 mm, optionally at least 340 mm.

In other words, the transmission is configured to connect a prime mover to one or more driveshafts (for driving the ground engaging structure) which are spaced apart from the prime mover by such a distance. Put another way, such a transmission provides a “long-drop” configuration which is useful for applications where an output shaft of the prime mover is substantially higher than a driveshaft of the working vehicle. For example, in articulated loaders or telescopic handlers where the engine is mounted higher than in other working vehicles such as fixed body telescopic handlers.

Optionally, the transmission is arranged so that the first input member is provided vertically above the output member.

Optionally, the prime mover and the hydraulic drive motor are positioned on the same side of the transmission. This may facilitate a more compact arrangement at an opposing side of the transmission, which may be particularly useful for articulated working vehicles such as articulated loaders or articulated telescopic handlers.

A further aspect of the teachings provides a driveline arrangement for a working vehicle comprising a ground engaging structure. The driveline arrangement comprises: a transmission comprising an output member, a first input member for driving the output member in a mechanical drive mode, and a second input member for driving the output member in a hydrostatic drive mode; a prime mover configured to drive the first input member of the transmission; a hydraulic drive motor configured to drive the second input member of the transmission; a hydraulic pump for supplying pressurized hydraulic fluid to drive the hydraulic drive motor, wherein the hydraulic pump is drivable by the prime mover; and one or more output driveshafts coupled to the output member of the transmission, for driving the ground engaging structure of the working vehicle. The hydraulic pump is a through-driven hydraulic pump positioned between the prime mover and the first input member of the transmission.

In other words, the hydraulic pump comprises an input side directly coupled to an output driveshaft of the prime mover and an output side directly coupled to an intermediate driveshaft for driving the first input member of the transmission.

Such a configuration provides a more compact driveline arrangement than alternative arrangements, for example, arrangements in which the hydraulic pump is coupled to an output shaft of the transmission.

Optionally, the driveline arrangement further comprises an intermediate driveshaft for driving the first input member of the transmission, wherein the hydraulic pump comprises an input side directly coupled to an output driveshaft of the prime mover and an output side directly coupled to the intermediate driveshaft.

Such a configuration provides a more compact driveline arrangement than alternative arrangements, for example, arrangements in which the hydraulic pump is coupled to an output shaft of the transmission.

Optionally, the hydraulic pump is mounted directly to the prime mover. This provides a compact arrangement.

Optionally, the first input member of the transmission and the output member of the transmission are spaced apart from each other by a spacing distance transverse to their respective axes of rotation, wherein the spacing distance is at least 220 mm, optionally at least 240 mm, optionally at least 260 mm, optionally at least 280 mm, optionally at least 300 mm, optionally at least 320 mm, optionally at least 340 mm.

In other words, the transmission is configured to connect a prime mover to one or more driveshafts (for driving the ground engaging structure) which are spaced apart from the prime mover by such a distance. Put another way, such a transmission provides a “long-drop” configuration which is useful for applications where an output shaft of the prime mover is substantially higher than a driveshaft of the working vehicle. For example, in articulated loaders or telescopic handlers where the engine is mounted higher than in other working vehicles such as fixed body telescopic handlers.

Optionally, the transmission is arranged so that the first input member is provided vertically above the output member.

Optionally, the prime mover and the hydraulic drive motor are positioned on the same side of the transmission. This may facilitate a more compact arrangement at an opposing side of the transmission, which may be particularly useful for articulated working vehicles such as articulated loaders or articulated telescopic handlers.

A further aspect of the teachings provides a driveline arrangement for a working vehicle comprising a ground engaging structure. The driveline arrangement comprises: a transmission comprising an output member, a first input member for driving the output member in a mechanical drive mode, and a second input member for driving the output member in a hydrostatic drive mode; a prime mover configured to drive the first input member of the transmission; a hydraulic drive motor configured to drive the second input member of the transmission; a hydraulic pump for supplying pressurized hydraulic fluid to drive the hydraulic drive motor, wherein the hydraulic pump is drivable by the prime mover; and one or more output driveshafts coupled to the output member of the transmission, for driving the ground engaging structure of the working vehicle. The first input member of the transmission and the output member of the transmission are spaced apart from each other by a spacing distance transverse to their respective axes of rotation, wherein the spacing distance is at least 220 mm, optionally at least 240 mm, optionally at least 260 mm, optionally at least 280 mm, optionally at least 300 mm, optionally at least 320 mm, optionally at least 340 mm.

In other words, the transmission is configured to connect a prime mover to one or more driveshafts (for driving the ground engaging structure) which are spaced apart from the prime mover by such a distance. Put another way, such a transmission provides a “long-drop” configuration which is useful for applications where an output shaft of the prime mover is substantially higher than a driveshaft of the working vehicle. For example, in articulated loaders or telescopic handlers where the engine is mounted higher than in other working vehicles such as fixed body telescopic handlers.

Optionally, the transmission is arranged so that the first input member is provided vertically above the output member.

Optionally, the prime mover and the hydraulic drive motor are positioned on the same side of the transmission. This may facilitate a more compact arrangement at an opposing side of the transmission, which may be particularly useful for articulated working vehicles such as articulated loaders or articulated telescopic handlers.

A further aspect of the teachings provides a working vehicle comprising a driveline arrangement as disclosed herein, and a ground engaging structure coupled to the one or more output driveshafts of the driveline arrangement. Such a working vehicle benefits from the advantages of the driveline arrangement outlined above.

Optionally, the working vehicle further comprises a control system configured to engage the transmission in the hydrostatic drive mode when the working vehicle is travelling at speeds below a threshold speed, and to engage the transmission in the mechanical drive mode when the working vehicle is travelling at speeds at or above the threshold speed.

Optionally, the threshold speed is greater than 20 km/h, optionally greater than 25 km/h, optionally greater than 30 km/h, optionally greater than 35 km/hour, optionally greater than 40 km/hour.

Known hydrostatic drives on hybrid transmissions are limited to less than 20 km/h speeds, with a mechanical drive being used for speeds above 20 km/h. Since working vehicles are sometimes required to travel at significantly higher speeds than 20 km/h (e.g., when travelling along the road), the mechanical drives on such transmissions have used multiple gear ratios. For example, the mechanical drive may have a first gear ratio optimized for speeds of 20-30 km/h, a second gear ratio optimized for speeds of 30-40 km/h, and a third gear ratio optimized for speeds above 40 km/h. However, it has been found that by having a threshold speed for the hydrostatic drive mode which is greater than 20 km/h (e.g., greater than 25, 30, 35, or 40 km/h), good mechanical driving performance can be achieved with a fixed gear ratio instead. This allows the number of components of the transmission to be reduced, which simplifies manufacturing and reduces costs.

### BRIEF DESCRIPTION OF DRAWINGS

Embodiments will now be described by way of example only with reference to the accompanying figures, in which:

FIG. 1 is a side view of a working vehicle according to an embodiment;

FIG. 2 is a schematic side view of a driveline arrangement of the working vehicle of FIG. 1;

FIG. 3 is a schematic plan view of the driveline arrangement of FIG. 2;

FIG. 4 is a first side view of the driveline arrangement of FIGS. 2 and 3;

FIG. 5 is a second side view of the driveline arrangement of FIGS. 2 to 4;

FIG. 6 is a plan view of the driveline arrangement of FIGS. 2 to 5;

FIG. 7 is a sectional view of a transmission of the driveline arrangement of FIGS. 2 to 6; and

FIG. 8 is a perspective view of the transmission of FIG. 7 with the casing removed.

### DETAILED DESCRIPTION

In the following detailed description, numerous specific details are set forth in order to provide a thorough understanding of various embodiments and the teachings. However, those skilled in the art will understand that: the present teachings may be practiced without these specific details or with known equivalents of these specific details; that the present teachings are not limited to the described embodiments; and, that the present teachings may be practiced in a variety of alternative embodiments. It will also be appreciated that well known methods, procedures, components, and systems may not have been described in detail.

References to vertical and horizontal in the present disclosure should be understood to be in relation to the machine when stood on horizontal ground in a non-working condition. The term axial is generally used in relation to the longitudinal axis of the machine. The term width is generally used in relation to the longitudinal length, that is, transverse to the length.

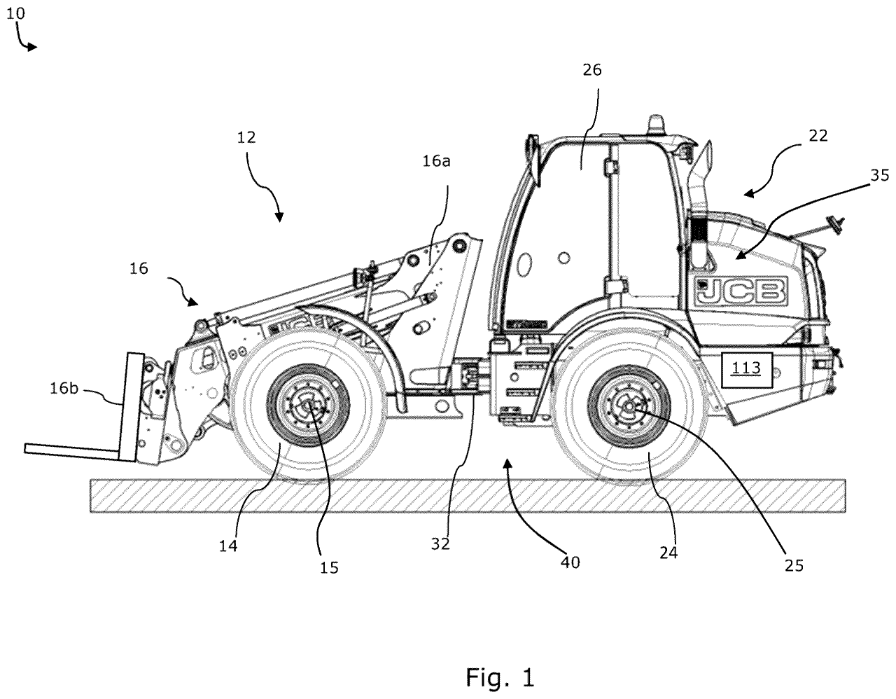

FIG. 1 shows a working vehicle 10 which is an example of one type of vehicle to which the teachings may be applied.

A working vehicle is an off-highway vehicle, for example those used in construction industries (e.g., backhoe loaders, excavators, slew excavators, telescopic handlers, forklifts, skid-steer loaders, dump trucks, bulldozers, graders), agricultural industries (e.g., tractors, combine harvesters, self-propelled harvesters, and sprayers), quarrying (e.g., loading shovels, dump trucks), and forestry (e.g., timber harvesters, feller bunchers).

In the illustrated embodiment, the working vehicle 10 is a telescopic wheel loader. However, it shall be appreciated that in other embodiments, the teachings may be applied to other forms of vehicle, working or otherwise.

The working vehicle 10 depicted in FIG. 1 is made up of a front chassis 12 and a rear chassis 22 which are joined together via an articulated connection 32, which allows the front chassis 12 to pivot relative to the rear chassis 22.

The working vehicle has a ground engaging structure 40 for moving the working vehicle 10 over the ground. In particular, the ground engaging structure 40 includes a first set of wheels 14 provided on the front chassis 12 for moving the front chassis 12 over the ground. The first set of wheels 14 are connected via a first axle 15. The ground engaging structure 40 also includes a second set of wheels 24 provided on the rear chassis 22 for moving the rear chassis 22 over the ground. The second set of wheels 24 are connected via a second axle 25.

A working arm 16 is attached to the front chassis 12 of the working vehicle 10. The working arm 16 includes a boom 16a which is pivotally attached to the front chassis 12, and an implement 16b which is pivotally attached to a free end of the boom 16a. In the illustrated embodiment, the implement 16b is a fork. In other embodiments, the implement may be a bucket, which is used for handling loose materials such as grain or aggregate. However, in alternative embodiments, numerous alternative implements may be used such as a pallet fork, silage or manure forks, a bale grab, or a lifting jib.

The working arm 16 is operably connected to a series of hydraulic actuators (not shown) for raising and lowering the boom 16a and for tilting and operating the implement 16b attached to the free end of the boom 16a. The manner in which the working arm 16 is operated is not central to the present teachings and hence shall not be described in further detail.

The working vehicle 10 also includes a prime mover (not shown in FIG. 1) mounted to the rear chassis 22. A cab 26 is further mounted to the rear chassis 22 forward of the prime mover. The cab 26 is provided with a collection of controls (not shown) for moving the working arm 16, maneuvering the working vehicle 10 and/or controlling other functions of the working vehicle 10.

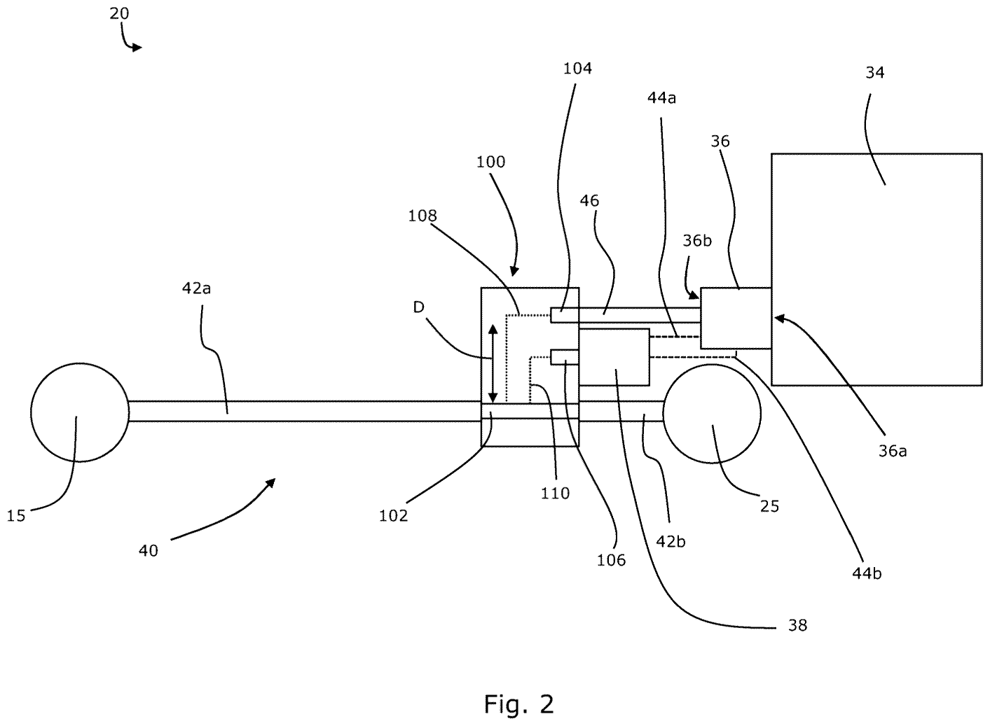

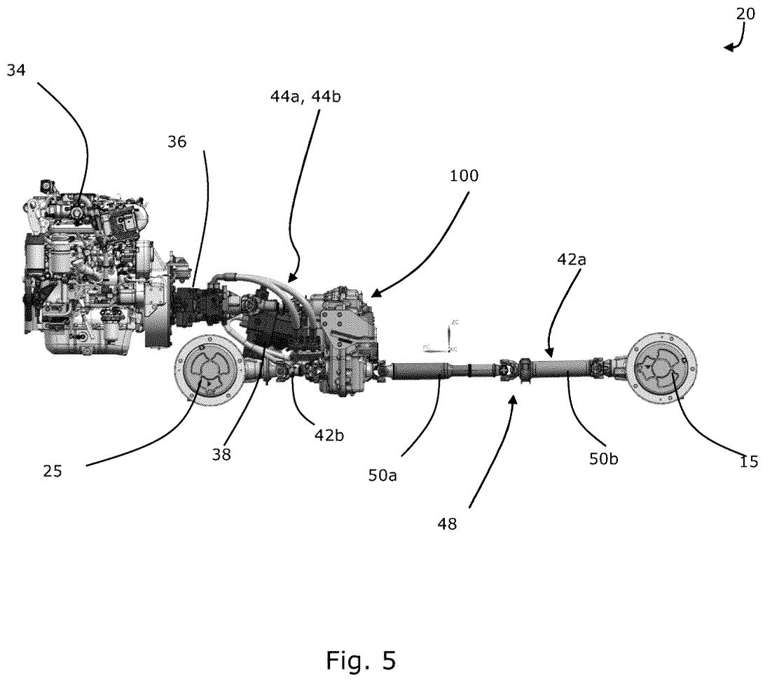

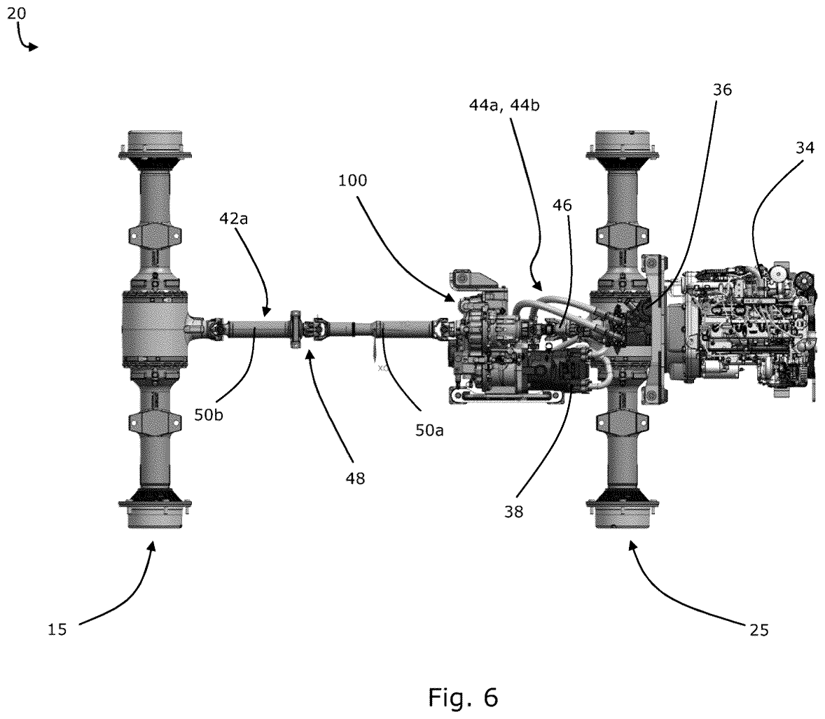

As will be described in more detail below with reference to FIGS. 2 to 6, during operation, mechanical energy is transmitted from the prime mover to a transmission which subsequently transmits the mechanical energy onto at least one of the first or second axles via one or more driveshafts.

Referring now to FIGS. 2 to 6, the driveline arrangement of the working vehicle 10 is indicated at 20.

The driveline arrangement 20 includes a prime mover 34, a hydraulic pump 36, a hydraulic drive motor 38, a transmission 100, and one or more output driveshafts 42a, 42b for driving the ground engaging structure 40 of the working vehicle 10.

The prime mover 34 converts chemical or electrical energy into mechanical energy for driving the wheels 14, 24 of the working vehicle 10. In the illustrated embodiment, the prime mover 34 is an engine. In particular, the prime mover 34 is an internal combustion engine which converts chemical energy in the form of petroleum fuel (e.g., diesel or gasoline) into mechanical energy for driving the wheels 14, 24 of the working vehicle 10. However, in other embodiments, the prime mover 34 may be a hydrogen-fueled internal combustion engine (or HICE), or an electric motor powered by a hydrogen fuel cell or batteries, or a combination of the above.

As will be described in more detail below, the transmission 100 has an output member 102, a first input member 104 for driving the output member 102 in a mechanical drive mode, and a second input member 106 for driving the output member 102 in a hydrostatic drive mode. The transmission 100 is operable to transmit drive from the first and second input members 104, 106 to the output member 102 via respective first and second drive paths 108, 110 (shown schematically by the dotted lines on FIG. 2).

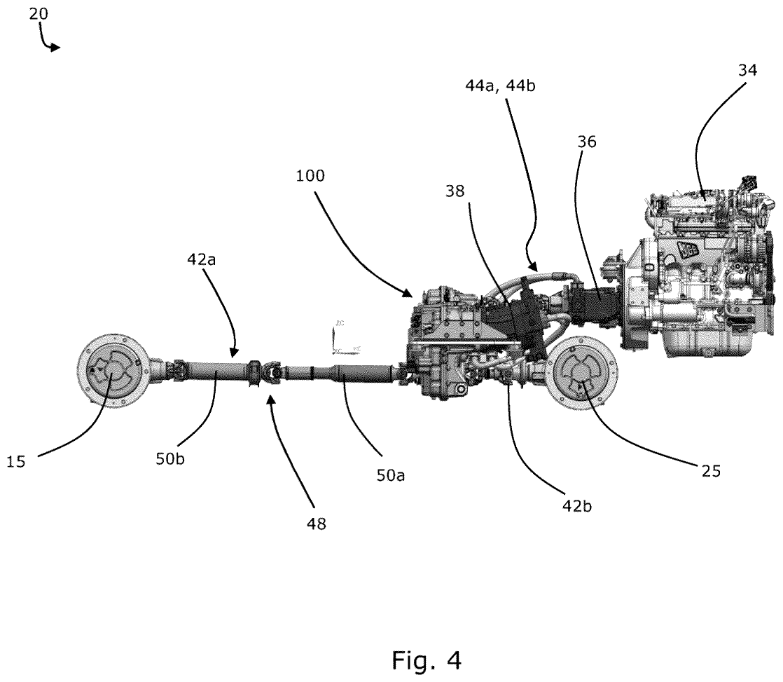

The one or more output driveshafts 42a, 42b are coupled to the output member 102 of the transmission 100. In this way, drive transmitted from the first and second input members 104, 106 to the output member 102 via the respective first and second drive paths 108, 110 can be used for driving the ground engaging structure 40 of the working vehicle 10. In the illustrated embodiment, there is a first output driveshaft 42a which transmits drive from the output member 102 of the transmission to the first axle 15. The first output driveshaft 42a has a universal joint 48 which splits the first output driveshaft 42a into a rear portion 50a and a front portion 50b (illustrated on FIGS. 4 to 6). This universal joint 48 allows the first output driveshaft 42a to pivot with the articulated connection 32 of the telescopic handler whilst still transmitting drive to the first axle 15.

In the illustrated embodiment, there is also a second output driveshaft 42b which transmits drive from the output member 102 of the transmission 100 to the second axle 25. In this way, the driveline arrangement 20 can transfer drive to both the first and second axles 15, 25 and hence the working vehicle 10 has an all-wheel drive (or four-wheel drive) functionality.

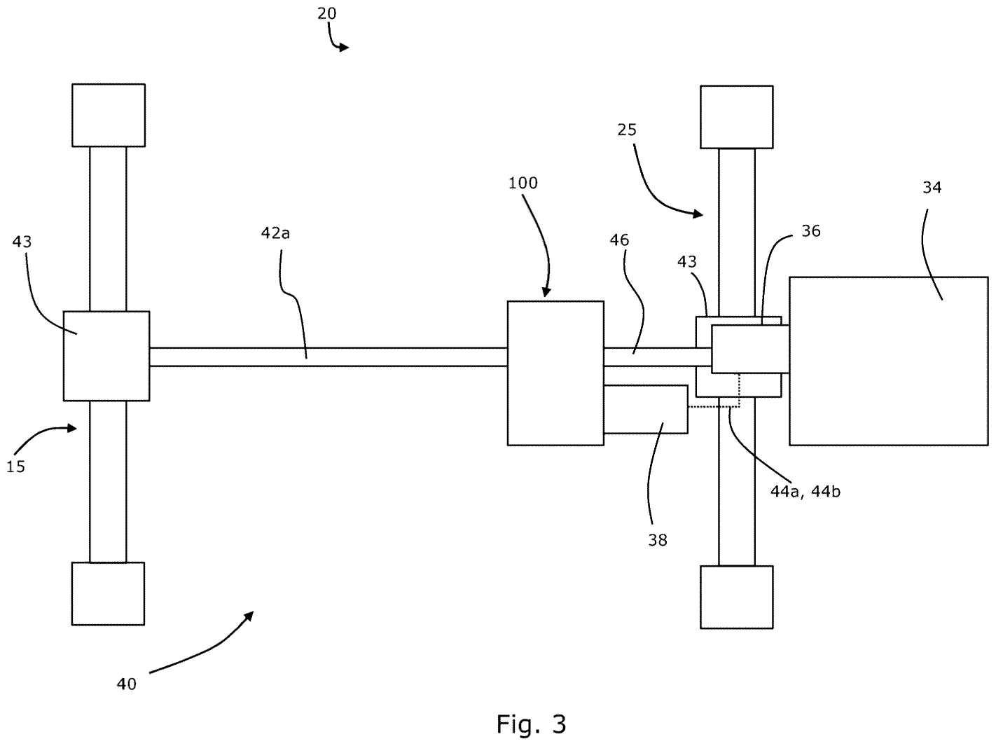

In the illustrated embodiment, the first and second axles 15, 25 each include a gear train 43 (shown on FIG. 3) which transmits rotation of the output driveshafts 42a, 42b to rotation of the respective axles 15, 25. The gear train 43 may be a differential device, or any other suitable type of gear train, as is known in the art.

In other embodiments, the driveline arrangement 20 may only transfer drive to one of the first or second axles 15, 25 (i.e., one of the output driveshafts 42a, 42b may be omitted). In such embodiments, the working vehicle 10 only has a two-wheel drive functionality.

The prime mover 34 is configured to drive the first input member 104 of the transmission 100, and the hydraulic drive motor 38 is configured to drive the second input member 106 of the transmission 100. In this way, the transmission 100 is operable to transmit drive from the prime mover 34 to the output member 102 in a mechanical drive mode, or to transmit drive from the hydraulic drive motor 38 to the output member 102 in a hydrostatic drive mode.

The hydraulic pump 36 is configured to supply pressurized hydraulic fluid to drive the hydraulic drive motor 38. In particular, the hydraulic pump 36 is connected to the hydraulic drive motor 36 by a pair of hydraulic fluid lines 44a, 44b (shown schematically as dashed lines on FIG. 2). It will be understood that the hydraulic pump 36 supplies pressurized hydraulic fluid along a first of the hydraulic fluid lines 44a, 44b to the hydraulic drive motor 38, and the other of the hydraulic fluid lines 44a, 44b provides a return flow from the hydraulic drive motor 38 to the hydraulic pump 36. In this way, the hydraulic pump 36 and hydraulic drive motor 38 are connected in a closed circuit. A hydraulic charge pump (not shown) and associated fluid lines may be provided for charging the closed circuit with hydraulic fluid (e.g., at start-up of the working vehicle 10).

In some embodiments, hydraulic fluid can selectively be supplied to the hydraulic drive motor 38 in either direction. This facilitates both forwards and reverse movement of the working vehicle 10 using the hydrostatic drive mode of the transmission 100. This may be achieved by having a bidirectional hydraulic pump 36, or via the use of one or more directional control valves provided between the hydraulic pump 36 and the hydraulic drive motor 38.

In the illustrated embodiment, the hydraulic pump 36 is drivable by the prime mover 34. In particular, the hydraulic pump 36 is a through-driven hydraulic pump positioned between the prime mover 34 and the first input member 104 of the transmission 100. In other words, the hydraulic pump 36 has an input side 36a directly coupled to an output driveshaft of the prime mover 34 and an output side 36b directly coupled to an intermediate driveshaft 46 for driving the first input member 104 of the transmission 100. In alternative embodiments, the hydraulic pump 36 is coupled to an output shaft of the transmission 100 (e.g., so that it is drivable by the prime mover 34, but not through-driven between the prime mover 34 and the transmission 100).

The through-driven configuration of the hydraulic pump 36 provides a compact driveline arrangement 20, which is particularly beneficial for working vehicles such as the telescopic wheel loader 10 of FIG. 1. In particular, it will be understood that the transmission 100 has to fit between the first and second axles 15, 25 so that the first and second output driveshafts 42a, 42b can be connected to the respective axles 15, 25. However, because of the articulated connection 32 there is a relatively small space in which the transmission 100 can be located (i.e., between the articulated connection 32 and the second axle 25). Therefore, providing the hydraulic pump 36 between the prime mover 34 and the transmission 100 (e.g., as opposed to being coupled to an output shaft on a far side of the transmission 100) allows the hydraulic pump 36 to be located in a region of the rear chassis 22 where there is comparatively more space.

In the illustrated embodiment, the hydraulic pump 36 is mounted directly to the prime mover 34, which provides a compact arrangement. In alternative embodiments, the hydraulic pump 36 is connected to the prime mover 34 via a further intermediate driveshaft.

In the illustrated embodiment, the prime mover 34 and the hydraulic drive motor 38 are positioned on the same side of the transmission 100, in particular, on a rear side of the transmission 100. This facilitates a more compact arrangement at an opposing side (i.e., a front side) of the transmission 100, which is particularly beneficial for working vehicles such as the telescopic wheel loader 10 of FIG. 1. In particular, as mentioned above, due to the small space for locating the transmission 100 between the articulated connection 32 and the second axle 25, there is comparatively more space on the rear side of the transmission 100 than on the front side. Therefore, locating the prime mover 34 and the hydraulic drive motor 38 on the same rear side of the transmission 100 allows these components to be positioned in a region of the rear chassis 22 where there is comparatively more space.

In the illustrated embodiment, the first input member 104 of the transmission 100 and the output member 102 of the transmission are spaced apart from each other by a spacing distance D transverse to their respective axes of rotation. In the illustrated embodiment, the spacing distance D is at least 220 mm, optionally at least 240 mm, optionally at least 260 mm, optionally at least 280 mm, optionally at least 300 mm, optionally at least 320 mm, optionally at least 340 mm. For example, the spacing distance D may be around 340 mm. In other words, the transmission 100 is configured to connect a prime mover (e.g., an output shaft of the prime mover 34) to the output driveshafts 42a, 42b which are spaced apart from the prime mover by such a spacing distance D. Put another way, such a transmission 100 provides a “long-drop” configuration.

The “long-drop” configuration is particularly beneficial for working vehicles such as the telescopic wheel loader 10 of FIG. 1. In particular, as can be seen in FIG. 1, the rear chassis 22 includes an enclosure 35 (e.g., an engine bay) which houses the prime mover 34 and which is relatively high in the working vehicle 10 in comparison to the first and second axles 15, 25 and associated driveshafts 42a, 42b.

In the illustrated embodiment, the transmission 100 is arranged so that the first input member 104 is provided vertically above the output member 102, which facilitates the “long-drop” configuration for dropping from the prime mover 34 to the driveshafts 42a, 42b described above.

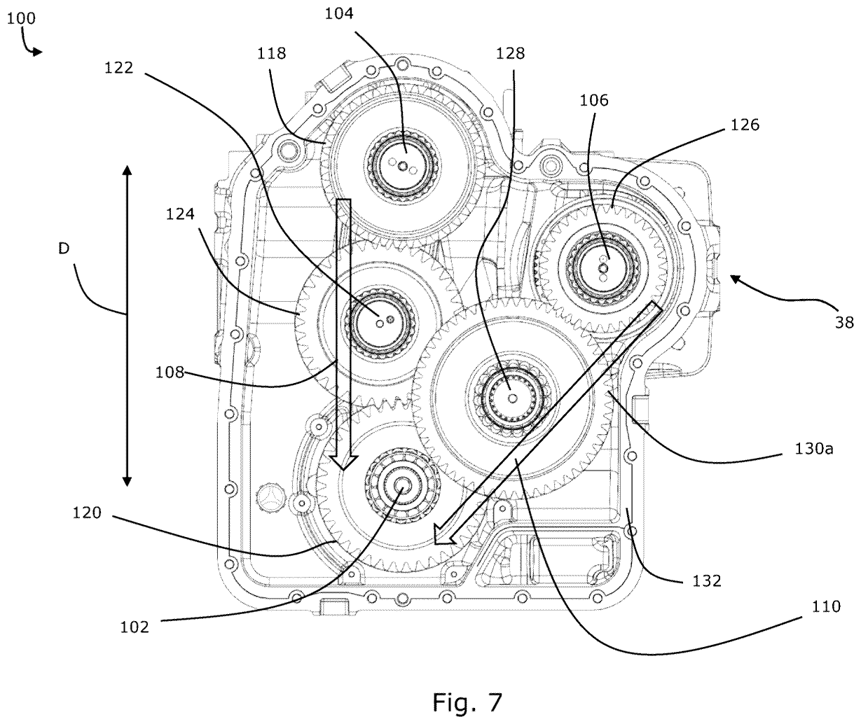

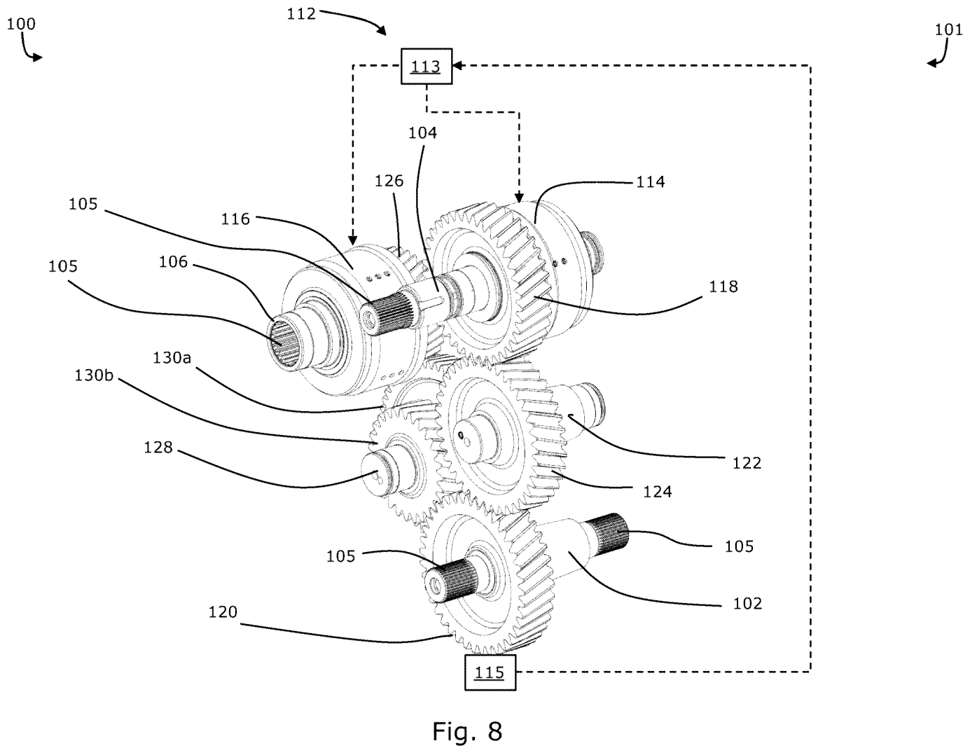

Referring now to FIGS. 7 and 8, the transmission 100 of the driveline arrangement 20 is shown in more detail. The transmission 100 has a number of internal components inside a casing 132. The casing 132 is shown in the cross-sectional view of FIG. 7, but has been omitted from the perspective view of FIG. 8 to clearly show the internal components of the transmission 100.

As mentioned above, the transmission 100 has an output member 102 for driving the ground engaging structure 40 of the working vehicle 10. The transmission 100 also has a first input member 104 connectable to a prime mover (e.g., to an output shaft of the prime mover 34), and the transmission 100 is operable to transmit drive from the first input member 104 via a first drive path 108 to the output member 102 in a mechanical drive mode. The transmission 100 also has a second input member 106 drivable by the operation of the hydraulic drive motor 38, and the transmission 100 is operable to transmit drive from the second input member 106 via a second drive path 110 to the output member 102 in a hydrostatic drive mode.

In the illustrated embodiment, the output member 102 has splines 105 (external splines in this embodiment) on each end for coupling to the output driveshafts 42a, 42b of the driveline arrangement 20. Similarly, the first input member 104 has splines 105 (external splines in this embodiment) at one end for coupling to the intermediate driveshaft 46 of the driveline arrangement 20 (or directly to an output shaft of the prime mover 34 in other embodiments). Similarly, the second input member 106 has splines 105 (internal splines in this embodiment) at one end for coupling to an output shaft of the hydraulic drive motor 38. It will be understood that in other embodiments, other combinations of internal or external splines 105 may be provided, or the output member 102 and input members 104, 106 may be configured for coupling to the respective shafts via another means (e.g., using grub screws or the like).

In the illustrated embodiment, the transmission 100 is configured so that there is a fixed ratio of rotation speed of the first input member 104 to rotation speed of the output member 102 in the mechanical drive mode. In other words, the first drive path 108 defines a fixed gear ratio, and there are no other drive paths connecting the first input member 104 to the output member 102. This contrasts with arrangements which include a mechanical drive train with a plurality of alternative gear ratios which are selectable by a gear ratio selection apparatus.

An advantage of having a fixed ratio of rotation speed of the first input member 104 to rotation speed of the output member 102 is that it reduces the number of components required compared to arrangements with multi-ratio drive trains. This provides a more compact transmission 100 which is easier and cheaper to manufacture. Furthermore, it has been found that a suitable driving performance for a working vehicle 10 can be obtained by having a hydrostatic drive mode for lower speed driving and a mechanical drive mode with a fixed gear ratio for higher speed driving. This contrasts with the conventional approach of having mechanical drive trains with a plurality of alternative gear ratios for different speeds of driving, even when an additional hydrostatic drive mode is provided.

It will be understood that the hydraulic drive motor 38 and the transmission 100 can collectively be considered a “transmission system” 101 which receives mechanical and hydrostatic inputs and converts to mechanical output.

The transmission system 101 has a control system 112 configured to engage the transmission 100 in the hydrostatic drive mode when the working vehicle 10 is travelling at speeds below a threshold speed, and to engage the transmission 100 in the mechanical drive mode when the working vehicle 10 is travelling at speeds at or above the threshold speed. Such a control system 112 may include a controller 113 which may be part of the working vehicle 10, as illustrated in FIG. 1 (e.g., a main ECU of the working vehicle 10).

The controller 113 may receive an input from a speed sensor 115 which provides a signal indicative of the travelling speed of the working vehicle 10 (as shown by the dashed line linking speed sensor 115 and controller 113 on FIG. 8). The speed sensor 115 may include: a vehicle speedometer; a sensor configured to detect a rate of rotation of a shaft of the transmission 100 (e.g., the output member 102); a sensor configured to detect a rate of rotation of the output driveshafts 42a, 42b; a sensor configured to detect a rate of rotation of the first and/or second axle 15, 25; a GPS sensor; or any other suitable sensor. In the illustrated embodiment, the speed sensor 115 is configured to detect gear teeth of the output gear 120 passing by the speed sensor 115 to determine a rate of rotation of the output member 102.

The controller 113 may send output signals configured to actuate first and second clutch devices 114, 116 of the transmission 100 in order to engage the mechanical drive mode or hydrostatic drive mode (as shown by the dashed lines linking the controller 113 and clutch devices 114, 116 on FIG. 8). The first and second clutch devices 114, 116 are described in more detail below.

In some embodiments, the threshold speed is greater than 20 km/h. For example, greater than 25 km/h, greater than 30 km/h, greater than 35 km/hour, or greater than 40 km/hour. Known hydrostatic drives on hybrid transmissions are limited to less than 20 km/h speeds, with a mechanical drive being used for speeds above 20 km/h. Since working vehicles are sometimes required to travel at significantly higher speeds than 20 km/h (e.g., when travelling along the road), the mechanical drives on such transmissions have used multiple gear ratios. For example, the mechanical drive on known vehicles may have a first gear ratio optimized for speeds of 20-30 km/h, a second gear ratio optimized for speeds of 30-40 km/h, and a third gear ratio optimized for speeds above 40 km/h. However, it has been found that by having a threshold speed for the hydrostatic drive mode which is greater than 20 km/h (e.g., greater than 25, 30, 35, or 40 km/h), good mechanical driving performance can be achieved with a fixed gear ratio instead. This allows the number of components of the transmission 100 to be reduced, which simplifies manufacturing and reduces costs.

As mentioned above, the first input member 104 and the output member 102 are spaced apart from each other by a spacing distance D transverse to their respective axes of rotation. In the illustrated embodiment, the spacing distance D is at least 220 mm, optionally at least 240 mm, optionally at least 260 mm, optionally at least 280 mm, optionally at least 300 mm, optionally at least 320 mm, optionally at least 340 mm (e.g., around 340 mm).

As will be apparent from the description of the driveline arrangement 20 above, the transmission 100 is configured to be mounted in a driveline arrangement 20 so that the first input member 104 is provided vertically above the output member 102, to provide a “long-drop” configuration.

As mentioned above, the transmission 100 has a first clutch device 114. The first clutch device 114 has an engaged state configured to connect the first input member 104 to the first drive path 108 when the transmission 100 is in the mechanical drive mode, and a disengaged state configured to disconnect the first input member 104 from the first drive path 108 when the transmission 100 is in the hydrostatic drive mode. Similarly, the transmission 100 has a second clutch device 116. The second clutch device 116 has an engaged state configured to connect the second input member 106 to the second drive path 110 when the transmission 100 is in the hydrostatic drive mode, and a disengaged state configured to disconnect the second input member 106 from the second drive path 110 when the transmission 100 is in the mechanical drive mode. The first and second clutch devices 114, 116 may be actuated to transition between the engaged and disengaged states via any suitable actuation means (e.g., hydraulic or electro-hydraulic actuators, electro-mechanical actuators, pneumatic actuators, electromagnetic actuators, or electrical actuators).

The first drive path 108 includes a first input gear 118 configured for rotation with the first input member 104 when the transmission is in the mechanical drive mode. It will be understood that the first clutch device 114 couples the first input gear 118 to the first input member 104 for co-rotation when the first clutch device 114 is in the engaged state.

The first drive path 108 also includes: an output gear 120 carried on the output member 102 for rotation with the output member 102; a first layshaft 122 between the first input member 104 and the output member 102; and one or more intermediate gears 124 carried on the first layshaft 122 for rotation with the first layshaft 122. Each of the one or more intermediate gears 124 of the first layshaft 122 is in permanent mesh with the first input gear 118 and/or the output gear 120.

In the illustrated embodiment, the one or more intermediate gears 124 of the first layshaft 122 comprise a single idler gear 124 in permanent mesh with both the first input gear 118 and the output gear 120. Such an idler gear 124 allows a distance between the first input gear 118 and the output gear 120 to be increased, without impacting the fixed gear ratio. This is useful for facilitating the “long-drop” spacing distance D described above.

As best illustrated in FIG. 7, the first input gear 118, idler gear 124 and output gear 120 are arranged in an approximately vertical line in which the idler gear 124 is positioned below the first input gear 118 and the output gear 120 is positioned below the idler gear 124. This is useful for facilitating the “long-drop” spacing distance D described above.

The second drive path 110 includes a second input gear 126 configured for rotation with the second input member 106 when the transmission 100 is in the hydrostatic drive mode. It will be understood that the second clutch device 116 couples the second input gear 126 to the second input member 106 for co-rotation when the second clutch device 116 is in the engaged state.

The second drive path 110 also includes: the output gear 120 carried on the output member 102 for rotation with the output member 102; a second layshaft 128 between the second input gear 126 and the output gear 120; and one or more intermediate gears 130a, 130b carried on the second layshaft 128 for rotation with the second layshaft 128. Each of the one or more intermediate gears 130a, 130b of the second layshaft 122 are in permanent mesh with the second input gear 126 and/or output gear 120.

In the illustrated embodiment, the one or more intermediate gears 130a, 130b of the second layshaft 128 comprise a first intermediate gear 130a in permanent mesh with the second input gear 126 and a second intermediate gear 130b in permanent mesh with the output gear 120. In this way, a gear ratio between the second input gear 126 and the output gear 120 can be set by selecting the number of teeth on the first and second intermediate gears 130a, 130b, without having to change the size of the second input gear 126 or output gear 120.

In the illustrated embodiment, the first intermediate gear 130a has more teeth than the second intermediate gear 130b. In this way, a gear ratio between the second input gear 126 and the output gear 120 can be influenced by the different number of teeth of the first and second intermediate gears 130a, 130b.

As best illustrated in FIG. 7, the transmission has a V-shaped layout in which the output member 102 is provided at a lower end of the V-shaped layout, the first input member 104 and first layshaft 122 define a first side of the V-shaped layout, and the second input member 106 and second layshaft 128 define a second side of the V-shaped layout. Such a V-shaped layout provides a package which is easy to reconfigure by removing one side of the V-shaped layout. For example, for applications where only a hydrostatic drive mode is required, the first input member 104, first input gear 118, first layshaft 122, and idler gear 124 can easily be omitted by virtue of being on a different side of the V-shaped configuration, without having to alter the casing 132 of the transmission 100.

The one or more embodiments are described above by way of example only and it will be appreciated that the variations are possible without departing from the scope of protection afforded by the appended claims. It should also be noted that whilst the appended claims set out particular combinations of features described above, the scope of the present disclosure is not limited to the particular combinations hereafter claimed, but instead extends to encompass any combination of features herein disclosed.

1. A transmission system for a working vehicle comprising a ground engaging structure, the transmission system comprising a hydraulic drive motor and a transmission comprising:
an output member for driving the ground engaging structure;
a first input member connectable to a prime mover, wherein the transmission is operable to transmit drive from the first input member via a first drive path to the output member in a mechanical drive mode; and
a second input member drivable by the operation of the hydraulic drive motor, wherein the transmission is operable to transmit drive from the second input member via a second drive path to the output member in a hydrostatic drive mode;
wherein the transmission is configured so that there is a fixed ratio of rotation speed of the first input member to rotation speed of the output member in the mechanical drive mode.

2. The transmission system of claim 1, further comprising a control system configured to engage the transmission in the hydrostatic drive mode when the working vehicle is travelling at speeds below a threshold speed, and to engage the transmission in the mechanical drive mode when the working vehicle is travelling at speeds at or above the threshold speed.

3. The transmission system of claim 2, wherein the threshold speed is greater than 20 km/h, optionally greater than 25 km/h, optionally greater than 30 km/h, optionally greater than 35 km/hour, optionally greater than 40 km/hour.

4. The transmission system of claim 1, wherein the first input member and the output member are spaced apart from each other by a spacing distance transverse to their respective axes of rotation, wherein the spacing distance is at least 220 mm, optionally at least 240 mm, optionally at least 260 mm, optionally at least 280 mm, optionally at least 300 mm, optionally at least 320 mm, optionally at least 340 mm.

5. The transmission system of claim 4, wherein the transmission is configured to be mounted in a driveline arrangement so that the first input member is provided vertically above the output member.

6. The transmission system of claim 1, wherein the transmission comprises a first side and a second side, wherein the first input member is connectable to a prime mover at the first side of the transmission, and wherein the second input member is connectable to the hydraulic drive motor at the first side of the transmission.

7. The transmission system of claim 1, wherein the transmission comprises a first clutch device having an engaged state configured to connect the first input member to the first drive path when the transmission is in the mechanical drive mode, and a disengaged state configured to disconnect the first input member from the first drive path when the transmission is in the hydrostatic drive mode.

8. The transmission system of claim 1, wherein the transmission comprises a second clutch device having an engaged state configured to connect the second input member to the second drive path when the transmission is in the hydrostatic drive mode, and a disengaged state configured to disconnect the second input member from the second drive path when the transmission is in the mechanical drive mode.

9. The transmission system of claim 1, wherein the first drive path comprises: a first input gear configured for rotation with the first input member when the transmission is in the mechanical drive mode, an output gear carried on the output member for rotation with the output member, a first layshaft between the first input member and the output member, and one or more intermediate gears carried on the first layshaft for rotation with the first layshaft, each of the one or more intermediate gears of the first layshaft being in permanent mesh with the first input gear and/or output gear.

10. The transmission system of claim 9, wherein the one or more intermediate gears of the first layshaft comprise a single idler gear in permanent mesh with both the first input gear and the output gear.

11. The transmission system of claim 9, wherein the first input gear, idler gear and output gear are arranged in an approximately vertical line in which the idler gear is positioned below the first input gear and the output gear is positioned below the idler gear.

12. The transmission system of claim 1, wherein the second drive path comprises: a second input gear configured for rotation with the second input member when the transmission is in the hydrostatic drive mode, an output gear carried on the output member for rotation with the output member, a second layshaft between the second input gear and the output gear, and one or more intermediate gears carried on the second layshaft for rotation with the second layshaft, each of the one or more intermediate gears of the second layshaft being in permanent mesh with the second input gear and/or output gear.

13. The transmission system of claim 12, wherein the one or more intermediate gears of the second layshaft comprise a first intermediate gear in permanent mesh with the second input gear and a second intermediate gear in permanent mesh with the output gear.

14. The transmission system of claim 13, wherein the first intermediate gear comprises more teeth than the second intermediate gear.

15. The transmission system of claim 9, wherein the second drive path comprises: a second input gear configured for rotation with the second input member when the transmission is in the hydrostatic drive mode, an output gear carried on the output member for rotation with the output member, a second layshaft between the second input gear and the output gear, and one or more intermediate gears carried on the second layshaft for rotation with the second layshaft, each of the one or more intermediate gears of the second layshaft being in permanent mesh with the second input gear and/or output gear, wherein the transmission comprises a V-shaped layout in which the output member is provided at a lower end of the V-shaped layout, the first input member and first layshaft define a first side of the V-shaped layout, and the second input member and second layshaft define a second side of the V-shaped layout.

16. A driveline arrangement for a working vehicle comprising a ground engaging structure, the driveline arrangement comprising:
the transmission system of claim 1;
a prime mover configured to drive the first input member of the transmission;
a hydraulic pump for supplying pressurized hydraulic fluid to drive the hydraulic drive motor, wherein the hydraulic pump is drivable by the prime mover; and
one or more output driveshafts coupled to the output member of the transmission, for driving the ground engaging structure of the working vehicle; optionally, wherein the hydraulic pump is a through-driven hydraulic pump positioned between the prime mover and the first input member of the transmission.

17. A driveline arrangement for a working vehicle comprising a ground engaging structure, the driveline arrangement comprising:
a transmission comprising an output member, a first input member for driving the output member in a mechanical drive mode, and a second input member for driving the output member in a hydrostatic drive mode;
a prime mover configured to drive the first input member of the transmission;
a hydraulic drive motor configured to drive the second input member of the transmission;
a hydraulic pump for supplying pressurized hydraulic fluid to drive the hydraulic drive motor, wherein the hydraulic pump is drivable by the prime mover; and
one or more output driveshafts coupled to the output member of the transmission, for driving the ground engaging structure of the working vehicle;
wherein the hydraulic pump is a through-driven hydraulic pump positioned between the prime mover and the first input member of the transmission;
optionally, wherein the hydraulic pump is mounted directly to the prime mover.

18. The driveline arrangement of claim 17, further comprising an intermediate driveshaft for driving the first input member of the transmission, wherein the hydraulic pump comprises an input side directly coupled to an output driveshaft of the prime mover and an output side directly coupled to the intermediate driveshaft.

19. A driveline arrangement for a working vehicle comprising a ground engaging structure, the driveline arrangement comprising:
a transmission comprising an output member, a first input member for driving the output member in a mechanical drive mode, and a second input member for driving the output member in a hydrostatic drive mode;
a prime mover configured to drive the first input member of the transmission;
a hydraulic drive motor configured to drive the second input member of the transmission;
a hydraulic pump for supplying pressurized hydraulic fluid to drive the hydraulic drive motor, wherein the hydraulic pump is drivable by the prime mover; and
one or more output driveshafts coupled to the output member of the transmission, for driving the ground engaging structure of the working vehicle;
wherein the first input member of the transmission and the output member of the transmission are spaced apart from each other by a spacing distance transverse to their respective axes of rotation, wherein the spacing distance is at least 220 mm, optionally at least 240 mm, optionally at least 260 mm, optionally at least 280 mm, optionally at least 300 mm, optionally at least 320 mm, optionally at least 340 mm.

20. A working vehicle comprising the driveline arrangement of claim 16 and a ground engaging structure coupled to the one or more output driveshafts of the driveline arrangement; optionally, further comprising a control system configured to engage the transmission in the hydrostatic drive mode when the working vehicle is travelling at speeds below a threshold speed, and to engage the transmission in the mechanical drive mode when the working vehicle is travelling at speeds at or above the threshold speed; optionally, wherein the threshold speed is greater than 20 km/h, optionally greater than 25 km/h, optionally greater than 30 km/h, optionally greater than 35 km/hour, optionally greater than 40 km/hour.
